(19) United States
(12) Patent Application Publication
(10) Pub. No.: US 2013/0153507 A1
(43) Pub. Date: Jun. 20, 2013

(54) METHOD FOR OPERATING WATER SOFTENING DEVICE AND WATER SOFTENING DEVICE

(71) Applicants: Shinya YAMAOKA, Ehime (JP); Shinichiro TESHIMA, Ehime (JP); Masaaki HIRAO, Ehime (JP)

(72) Inventors: Shinya YAMAOKA, Ehime (JP); Shinichiro TESHIMA, Ehime (JP); Masaaki HIRAO, Ehime (JP)

(73) Assignee: MIURA CO., LTD., Matsuyama-shi (JP)

(21) Appl. No.: 13/569,763

(22) Filed: Aug. 8, 2012

(30) Foreign Application Priority Data
Dec. 14, 2011 (JP) 2011-273510

(51) Int. Cl. C02F 1/42

(52) U.S. Cl. 210/678; 210/190

(57) ABSTRACT

A method for operating a water softening device, includes: producing soft water by passing raw water downward through a cation exchange resin bed which has a depth of 300 to 1500 mm and a ratio of the depth to a diameter being 1.8 to 3; and regenerating all the bed by generating an opposite flow of a regenerant by collecting the regenerant at an intermediate portion of the bed while supplying the regenerant from top and bottom sides of thereof, wherein the regenerating includes supplying the regenerant in a volume which gives a regeneration level of at least 1 to 6 eq/L-R, to a hardness leak prevention bed having a depth of 100 mm, and the producing after the regenerating includes supplying raw water having an electric conductivity of equal to or lower than 150 mS/m and having a total hardness of equal to or lower than 500 mgCaCO₃/L.

### CROSS-REFERENCE TO RELATED APPLICATION(S)

This application is based upon and claims the benefit of priority from Japanese Patent Application No. 2011-273510, filed Dec. 14, 2011, the entire contents of which are incorporated herein by reference.

### FIELD

The present invention relates to a method for operating a water softening device, and a water softening device.

### BACKGROUND

In a semiconductor manufacturing process, washing of electronic parts, and washing of medical apparatuses, high-purity pure water that does not contain impurities is used. In general, this type of pure water is produced by processing raw water such as groundwater and tap water with a reverse osmosis membrane (hereinafter, also an “RO membrane”).

In a pure water production system that uses an RO membrane, there occurs a phenomenon of what is called fouling that iron (typically, colloidal iron in an insolubilized state) contained in the raw water is deposited on a surface of the RO membrane, and a salt rejection rate and a permeate water volume decrease. Therefore, it is general that the raw water is pretreated with an iron removing device.

The iron removing device is a facility that removes an iron component of raw water, by insolubilizing the iron component by injecting an oxidizing agent into the raw water. However, when an oxidizing agent remains in supply water to the RO membrane, the membrane itself is degraded. Therefore, it is necessary to further provide an activated carbon filtering device at a latter stage of the iron removing device. Consequently, according to a conventional pure water production system, the pretreatment to remove the oxidizing agent that remains in the raw water becomes complex, and the increase of cost of producing water cannot be avoided.

The present applicant proposed a method of producing pure water capable of stably supplying high-purity pure water by increasing a salt rejection rate, while suppressing oxidization degradation of an RO membrane, by supplying soft water having hardness of equal to or lower than 5 mgCaCO₃/L to the RO membrane.

However, according to a conventional water softening device, it is difficult to produce high-purity soft water from which a hardness leakage level is sufficiently decreased, by using hard water of poor water quality. Further, it is difficult to secure a practical water collection volume. For example, according to a water softening device of a counter-flow regeneration system, an ion exchange resin bed easily flows in a regeneration process. Therefore, a regeneration rate of the ion exchange resin bed tends to become low, and it is difficult to constantly supply high-purity soft water to the RO membrane. Further, according to the water softening device of a split-flow regeneration system, an exit region needs to be substantially completely regenerated, in using hard water of poor water quality, and it is required to optimize a regeneration condition.

### SUMMARY OF THE INVENTION

A method for operating a water softening device, comprises: producing soft water by passing raw water downward through a cation exchange resin bed which has a depth of 300 to 1500 mm and a ratio of the depth to a diameter being 1.8 to 3; and regenerating a whole of the cation exchange resin bed by generating an opposite flow of a regenerant by collecting the regenerant at an intermediate portion of the cation exchange resin bed while supplying the regenerant from both sides of a top portion and a bottom portion of the cation exchange resin bed, wherein the regenerating includes supplying the regenerant in a volume which gives a regeneration level of at least 1 to 6 eq/L-R, to a hardness leak prevention bed having a depth of 100 mm on the bottom portion of the cation exchange resin bed, and the producing after the regenerating includes supplying raw water having an electric conductivity of equal to or lower than 150 mS/m and having a total hardness of equal to or lower than 500 mgCaCO₃/L.

### BRIEF DESCRIPTION OF THE DRAWINGS

FIG. 1 is an exemplary overall configuration diagram of a water treatment system according to an embodiment;

FIG. 2 is an exemplary schematic cross-sectional view of a water softening device in the embodiment;

FIG. 3 is an exemplary flowchart of a process performed by a control unit in the embodiment; and

FIGS. 4A and 4B are exemplary explanatory diagrams showing a basic process performed by the control unit in the embodiment.

### DETAILED DESCRIPTION OF PREFERRED EMBODIMENTS

Embodiments described herein relate to a method for operating a water softening device that uses a cation exchange resin, and a water softening device. First, a water treatment system according to the embodiment is described with reference to the drawings. An object of the embodiment is to provide a method for operating a water softening device and a water softening device capable of producing high-purity soft water from which a hardness leakage level is sufficiently decreased even when hard water of poor water quality is used, by substantially completely regenerating an exit region.

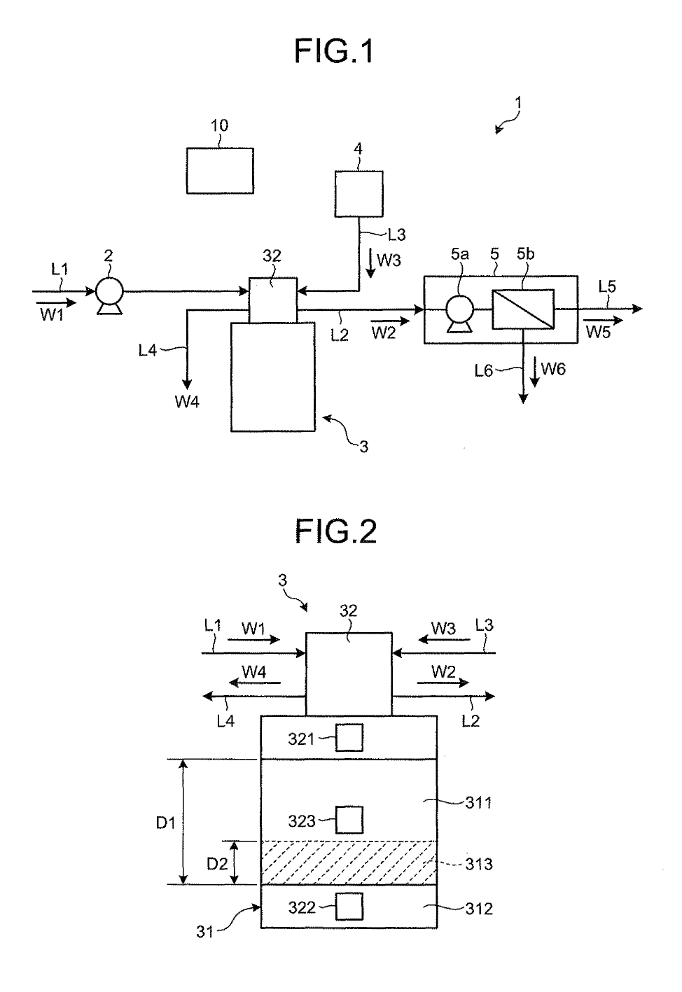

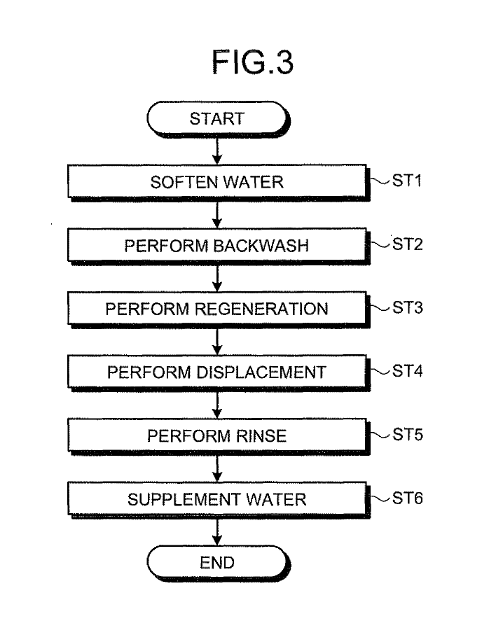

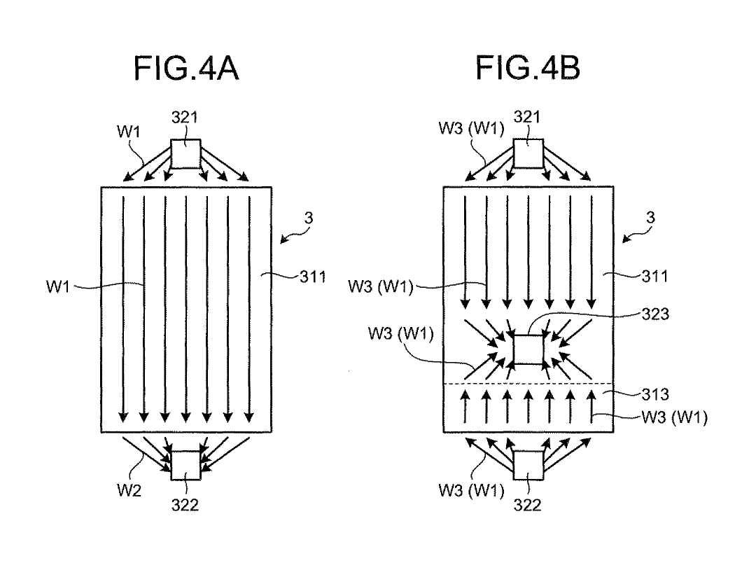

A water treatment system 1 is applied to a pure water production system that produces pure water from fresh water, for example. FIG. 1 is an overall configuration diagram of the water treatment system 1 according to the embodiment. FIG. 2 is a schematic cross-sectional view of a water softening device 3. FIG. 3 is a flowchart of a process performed by a control unit 10. FIGS. 4A and 4B are explanatory diagrams showing a basic process performed by the control unit 10.

As shown in FIG. 1, the water treatment system 1 according to the present embodiment includes a raw water pump 2, a water softening device 3, a salt water tank 4, a reverse osmosis membrane separation device 5, and the control unit 10. The water treatment system 1 also includes a raw water line L1, a soft water line L2, a salt water line L3, a drain line L4, a water passage line L5, and a concentrated water line L6,

The “line” in the present specification is a generic term of a line through which a fluid can pass such as a flow path, a channel, and a duct.

An end portion of an upstream side of the raw water line L1 is connected to a supply source (not shown) of raw water W1. On the other hand, an end portion of a downstream side of the raw water line L1 is connected to a process control valve 32 (described later) of the water softening device 3.

The raw water pump 2 is provided in the raw water line L1. The raw water pump 2 pressure feeds the raw water W1 such as tap water and groundwater that is supplied from a supply source, to the water softening device 3. The raw water pump 2 is electrically connected to the control unit 10 (described later) via a signal line (not shown). An operation (drive or stop) of the raw water pump 2 is controlled by the control unit 10.

A raw water passage valve (not shown) is provided in the raw water line L1. The raw water passage valve is operated to open and close the raw water line L1. A drive unit of a valve element of the raw water passage valve is electrically connected to the control unit 10 via a signal line (not shown). Opening and closing of the raw water passage valve is controlled by the control unit 10.

The raw water line L1, the raw water pump 2, the raw water passage valve not shown, and a raw water flowmeter (or a timer) not shown constitute a raw water supply unit in the present embodiment. The raw water flowmeter is a device for measuring a supply volume of raw water W1 in a water-softening process ST1 (described later), that is, a water collection volume of soft water W2, and is provided in the raw water line Li or the soft water line L2. The timer is a device for measuring a supply time of the raw water W1 in the water-softening process ST1, that is, a water collection time of the soft water W2, and is built in the control unit 10.

The raw water line L1, the raw water pump 2, and the raw water passage valve not shown also function as a raw water supply unit that supplies the raw water W1 having an electric conductivity of equal to or lower than 150 mS/m and having a total hardness of equal to or lower than 500 mgCaCO₃/L, to the water softening device 3, in the water-softening process ST1 after a regeneration process ST3 described later.

The water softening device 3 is a facility that produces soft water W2, by substituting a sodium ion (or a potassium ion) for a hardness component (a calcium ion and a magnesium ion) contained in the raw water W1 by a cation exchange resin bed 311 (described later). As shown in FIG. 2, the water softening device 3 is configured by mainly a pressure tank 31 and the process control valve 32 as a valve unit.

The pressure tank 31 is a based cylindrical body having an upper opening portion. The pressure tank 31 has the opening portion sealed with a lid member. Inside the pressure tank 31, there are accommodated the cation exchange resin bed 311 including cation exchange resin beads, and a supporting bed 312 including filtration gravel.

The cation exchange resin bed 311 functions as a processing material that softens the raw water W1. The cation exchange resin bed 311 is stacked at an upper portion of the supporting bed 312, inside the pressure tank 31. A depth D1 of the cation exchange resin bed 311 is set within a range of 300 to 1500 mm. A ratio (D1/Z) of a depth D1 to a diameter Z of a cation exchange resin bed 311 is set within a range of 1.8 to 3. This ratio D1/Z is set to avoid generating a regeneration-insufficiency portion due to a short circuit flow or a drift current of the regenerant, near a height of an intermediate screen 323 (described later) and at a portion apart from the intermediate screen 323 in a radial direction. That is, by setting the ratio Dl/Z to a range of 1.8 to 3, the whole of the cation exchange resin bed 311 can be uniformly regenerated, and a desired water collection volume can be secured.

The supporting bed 312 functions as a rectification member of a fluid to the cation exchange resin bed 311. The supporting bed 312 is accommodated at a bottom portion side of the pressure tank 31.

In the pressure tank 31, a top screen 321 that prevents flow out of the cation exchange resin beads is provided at a top portion of the cation exchange resin bed 311. The top screen 321 is connected via a first flow path (not shown) to each of various lines that constitute the process control valve 32.

A liquid distribution position and a liquid collection position by the top screen 321 are set near the top portion of the cation exchange resin bed 311, and at approximately a center portion of the cation exchange resin bed 311 in a radial direction. The top screen 321 functions as a top liquid distribution portion provided at the top portion of the cation exchange resin bed 311, and as a top liquid collection portion provided at the top portion of the cation exchange resin bed 311.

In the pressure tank 31, a bottom screen 322 that prevents flow out of the cation exchange resin beads is provided at a bottom portion of the cation exchange resin bed 311. The bottom screen 322 is connected via a second flow path (not shown) to each of various lines that constitute the process control valve 32.

A liquid distribution position and a liquid collection position by the bottom screen 322 are set near the bottom portion of the cation exchange resin bed 311, and at approximately a center portion of the cation exchange resin bed 311 in a radial direction. The bottom screen 322 functions as a bottom liquid distribution portion provided at the bottom portion of the cation exchange resin bed 311, and as a bottom liquid collection portion provided at the bottom portion of the cation exchange resin bed 311.

In the pressure tank 31, an intermediate screen 323 that prevents flow out of the cation exchange resin beads is provided, at an upper portion than a hardness leak prevention bed 313 (described later) and at an intermediate portion in a depth direction of the cation exchange resin bed 311. The intermediate screen 323 is connected via a third flow path (not shown) to each of various lines that constitute the process control valve 32.

A liquid collection position of the intermediate screen 323 is set near an intermediate portion of the cation exchange resin bed 311 in a depth direction, and at approximately a center portion of the cation exchange resin bed 311 in a radial direction. The intermediate screen 323 functions as an intermediate liquid collection portion that is provided at an intermediate portion of the cation exchange resin bed 311.

The process control valve 32 includes various lines, valves, and the like inside thereof. A process control valve 32 is configured to be switchable between a flow of the raw water W1 in the water-softening process ST1 of producing the soft water W2 by at least passing the raw water W1 in a downward flow form through the cation exchange resin bed 311, and a flow of the salt water W3 in the regeneration process ST3 of regenerating the whole of the cation exchange resin bed 311 by generating an opposed flow, an opposite flow, a counter flow, or a countercurrent of the salt water W3 by collecting the salt water W3 at an intermediate portion while distributing the salt water W3 as a regenerant from both sides of the top portion and the bottom portion of the cation exchange resin bed 311.

In the regeneration process ST3 according to the present embodiment, as shown in FIG. 2, the salt water W3 is supplied as a regenerant in a volume which gives a regeneration level of at least 1 to 6 eq/L-R, to a hardness leak prevention bed 313 (described later) having a depth D2 of 100 mm based on the bottom portion (that is, a bottom surface) of the cation exchange resin bed 311. The regeneration level is a regeneration agent volume that is used to regenerate an ion exchange resin of a unit capacity. When sodium chloride is used as a regeneration agent, 1 eq corresponds to 58.5 g.

The hardness leak prevention bed 313 is a region that needs to be sufficiently regenerated in the cation exchange resin bed 311, to prevent as much as possible a hardness leakage, in performing the water-softening process ST1 of changing hard water of poor water quality into the raw water W1. A sufficient depth of the hardness leak prevention bed 313 is 100 mm, and a hardness leakage can be prevented as much as possible by regenerating at least this limited region at a predetermined regeneration level.

The process control valve 32 is also configured to switch a flow of the raw water W1 in a displacement process ST4 of displacing the salt water W3 that is introduced, after the regeneration process ST3, by generating an opposed flow of the raw water W1 by collecting the raw water W1 at the intermediate portion of the cation exchange resin bed 311 while distributing the raw water W1 from both sides of the top portion and the bottom portion of the cation exchange resin bed 311 to the cation exchange resin bed 311.

An end portion of an upstream side of the drain line L4 is connected to the process control valve 32. The salt water W3 and the raw water W1 that are used in the regeneration process and the displacement process are drained as drain water W4, from the drain line L4.

Further, in the process control valve 32, a drive unit of a valve element provided inside thereof is electrically connected to the control unit 10 via a signal line (not shown) . Switching of a valve of the process control valve 32 is controlled by the control unit 10.

Each process performed by the water softening device 3 is described next.

In the water treatment system 1 according to the present embodiment, the control unit 10 (described later) repeatedly performs operations of the following processes ST1 to ST6 shown in FIG. 3, by switching a flow path of the process control valve 32.

ST1: A water-softening process of passing the raw water W1 through the whole of the cation exchange resin bed 311 downwards in the vertical direction.

ST2: A backwash process of passing the raw water W1 as wash water through the whole of the cation exchange resin bed 311 upwards in the vertical direction.

ST3: A regeneration process of passing the salt water W3 as a regenerant through the cation exchange resin bed 311 downwards in the vertical direction, and also passing the raw water W1 mainly through the hardness leak prevention bed 313 of the cation exchange resin bed 311 upwards in the vertical direction.

ST4: A displacement process of passing the raw water W1 as displacement water through the cation exchange resin bed 311 downwards in the vertical direction, and also passing the raw water W1 mainly through the hardness leak prevention bed 313 of the cation exchange resin bed 311 upwards in the vertical direction.

ST5: A rinse process of passing the raw water W1 as rinse water through the whole of the cation exchange resin bed 311 downwards in the vertical direction.

ST6: A water supplementing process of supplying the raw water W1 as supplementary water to the salt water tank 4.

Out of the processes ST1 to ST6, an operation method of the water-softening process ST1, the regeneration process ST3, and the displacement process ST4 as main processes is described next.

In the water-softening process ST1, as shown in FIG. 4A, the soft water W2 is produced, by distributing the raw water W1 from the top screen 321, and by passing the raw water W1 in a downward flow form through the whole of the cation exchange resin bed 311. The produced soft water W2 is collected from the bottom screen 322. In the water-softening process ST1 after the regeneration process ST3 described later is performed, the raw water W1 having an electric conductivity of equal to or lower than 150 mS/m and having a total hardness of equal to or lower than 500 mgCaCO₃/L is supplied.

In the regeneration process ST3, as shown in FIG. 4B, the salt water W3 is distributed from the top screen 321, and the salt water W3 is passed in a downward flow form through the cation exchange resin bed 311. At the same time, the salt water W3 is distributed from the bottom screen 322, and the salt water W3 is passed by an up flow to the cation exchange resin bed 311. With this arrangement, an opposed flow of the salt water W3 is generated, and the cation exchange resin bed 311 is generated. In the regeneration process ST3, the salt water W3 is passed to the cation exchange resin bed 311 at a linear velocity of 0.7 to 2 m/h. The salt water W3 in a volume which gives a regeneration level of 1 to 6 eq/L-R is supplied to the hardness leak prevention bed 313. The salt water W3 used after regenerating the cation exchange resin bed 311 is collected from the intermediate screen 323. In the regeneration process ST3, the whole of the cation exchange resin bed 311 is regenerated by a split-flow regeneration of generating an opposed flow of the salt water W3. Particularly, in the split-flow regeneration according to the embodiment, because the salt water W3 of a volume that becomes a specific regeneration level is supplied to the hardness leak prevention bed 313, a lower-side region of the cation exchange resin bed 311 including the hardness leak prevention bed 313 can be sufficiently regenerated.

In the displacement process ST4 that is performed after the regeneration process ST3, as shown in FIG. 4B, the raw water W1 is distributed from the top screen 321, and the raw water W1 is passed in a downward flow form through the cation exchange resin bed 311. At the same time, the raw water W1 is also distributed from the bottom screen 322, and the raw water W1 is passed by an up flow to the cation exchange resin bed 311. With this arrangement, an opposed flow of the raw water W1 is generated, and the salt water W3 introduced to the cation exchange resin bed 311 is displaced. The raw water W1 that passes the cation exchange resin bed 311 is collected from the intermediate screen 323. In the displacement process ST4, the raw water W1 is passed to the cation exchange resin bed 311 at a linear velocity of 0.7 to 2 m/h and by a displacement volume of 0.4 to 2.5 BV.

In the regeneration process ST3, a split-flow regeneration is performed to the whole of the cation exchange resin bed 311. Therefore, although the whole of the cation exchange resin bed 311 is substantially uniformly regenerated, particularly a lower-side region that includes the hardness leak prevention bed 313 can be sufficiently regenerated. Accordingly, in the water-softening process ST1, a water collection volume of the soft water W2 in high purity can be increased to a maximum limit. In the split-flow regeneration, a displacement volume is limited, while using the raw water to displace a regenerant. Consequently, the soft water W2 of target purity having little contamination of the hardness leak prevention bed 313 can be produced.

By performing the regeneration process ST3, in the subsequent water-softening process ST1, high-purity soft water W2 having a hardness leakage level of equal to or lower than 0.8 mgCaCO₃/L can be produced, when the raw water W1 having an electric conductivity of equal to or lower than 150 mS/m and having a total hardness of equal to or lower than 500 mgCaCO₃/L is supplied.

The backwash process ST2, the rinse process ST5, and the water supplementing process ST6 are not described with reference to drawings. After a series of the processes ST2 to ST6 to regenerate the cation exchange resin bed 311 ends, the water-softening process ST1 is performed again.

A configuration of the water treatment system 1 is described with reference to FIG. 1 again.

The salt water tank 4 stores the salt water W3 for regenerating the cation exchange resin bed 311. An end portion of an upstream side of the salt water line L3 is connected to the salt water tank 4. An end portion of a downstream side of the salt water line L3 is communicated to the process control valve 32, and is connected to each of various lines that constitute the process control valve 32. A salt water valve (not shown) is provided in the salt water line L3. The salt water valve opens and closes the salt water line L3. A salt water valve is built in the process control valve 32, and a drive unit of a valve element is electrically connected to the control unit 10 via a signal line (not shown) . Opening and closing of the salt water valve is controlled by the control unit 10. In the regeneration process ST3, the salt water W3 for regenerating the cation exchange resin bed 311 is delivered from the salt water tank 4 to the pressure tank 31.

The salt water tank 4, a salt water valve, an ejector, and a salt water flowmeter (which are not shown) constitute a regenerant supply unit in the present embodiment. The ejector is a pump element that is built in the process control valve 32. An end portion of a downstream side of the salt water line L3 is connected to an intake side of the ejector. The salt water flowmeter is provided in the salt water line L3 to be able to measure a supply volume of the salt water W3, during the performance of the regeneration process ST3.

The reverse osmosis membrane separation device 5 is a facility that performs a membrane separation process of separating the soft water W2 produced by the water softening device 3 into permeate water W5 from which dissolved water is removed and concentrated water W6 in which dissolved salt is concentrated, by a reverse osmosis membrane (RO membrane module 5b described later). The reverse osmosis membrane separation device 5 is connected to a downstream side of the water softening device 3 (process control valve 32) via the soft water line L2.

The reverse osmosis membrane separation device 5 includes a pressure pump 5a and an RO membrane module 5b. The pressure pump 5a pressurizes the soft water W2 delivered from the water softening device 3, and delivers the soft water W2 to the RO membrane module 5b. The RO membrane module 5b includes single or plural RO membrane elements (not shown). The reverse osmosis membrane separation device 5 performs a membrane separation process to the soft water W2 by the RO membrane elements, and produces the permeate water W5 and the concentrated water W6.

An end portion of an upstream side of the water passage line L5 is connected to a permeate water exit of the RO membrane module 5b. The permeate water W5 obtained by the reverse osmosis membrane separation device 5 is delivered to a secondary refining device or to a demand position as desalinated water via the water passage line L5. An end portion of an upstream side of the concentrated water line L6 is connected to a concentrated water exit of the RO membrane module 5b. The concentrated water W6 obtained by the reverse osmosis membrane separation device 5 is discharged to the outside via the concentrated water line L6. To keep a flow velocity on a membrane surface in a predetermined range, it may be arranged such that a part of the concentrated water W6 is reflowed to the soft water line L2 at an upstream side of the reverse osmosis membrane separation device 5, and a remainder of the concentrated water W6 is discharged to the outside.

The RO membrane module 5b according to the present embodiment has a reverse osmosis membrane (not shown) on a surface in which a skin layer of a negative electric characteristic made of a bridged wholly aromatic polyamide is formed. This reverse osmosis membrane increases a water permeability coefficient to 1.5×10⁻¹¹ m³·m⁻²√s⁻¹·Pa⁻¹ or higher and also increases a salt rejection rate to 99% or higher, when a sodium chloride aqueous solution of concentration 500 mg/L, pH 7.0, and a temperature 25° C. is supplied at an operating pressure 0.7 MPa, and a recovery rate 15%. The reverse osmosis membrane which is set to have this performance has a larger salt rejection rate (that is, [supply water EC]−[permeate water EC])/[supply water EC]×100) evaluated by electric conductivity (EC), as hardness of the supply water is lower, in a desalination process of fresh water. Therefore, a high salt rejection rate (usually, equal to or higher than 98.5%) can be maintained, by constantly supplying high-purity soft water W2 (raw power value equal to or lower than 0.8 mgCaCO₃/L) produced by the water softening device 3 that performs a split-flow regeneration.

The operating pressure is an average operating pressure that is defined by JIS K3802-1995 “Technical terms for membranes and membrane processes”. The operating pressure refers to an average value of an input pressure at a primary side and an exit pressure at a primary side of the RO membrane module 5b. The recovery rate refers to a proportion of a flow rate Q₂ of permeate water to a flow rate Q₁ of supply water (a sodium chloride aqueous solution, in this case) to the RO membrane module 5b (that is, Q₂/Q₁×100). The water permeability coefficient is a value obtained by dividing a flow rate [m³/s] of permeate water by a membrane area [m²] and an effective pressure [Pa], and is an index that indicates permeability performance of water in the reverse osmosis membrane. That is, the water permeability coefficient means a volume of water that permeates a unit area of a membrane per unit time when a unit effective pressure is operated. The effective pressure is defined by JIS K3802-1995 “Technical terms for membranes and membrane processes”. The effective pressure is a pressure obtained by subtracting an osmotic pressure difference and a secondary-side pressure from an operating pressure (average operating pressure) . The salt rejection rate is a value obtained from a calculation of concentration of specific salt (concentration of sodium chloride, in this case) before and after permeating a membrane. The salt rejection rate is an index that indicates block performance of dilute of a reverse osmosis membrane. The salt rejection rate is obtained from (1−C₂/C₁)×100, based on input concentration (C₁) to the RO membrane module 5b and concentration (C₂) of the permeate water.

A reverse osmosis membrane that satisfies a condition of a water permeability coefficient and a salt rejection rate according to the present embodiment is commercially available as a reverse osmosis membrane element. For the reverse osmosis membrane element, a type name “TMG20-400” manufactured by Toray Industries, Inc., a type name “RE8040-BLF” manufactured by Woongjin Chemical Co., Ltd., and a type name “ESPA1” manufactured by Nitto Denko Corporation, for example, can be used.

The control unit 10 is configured by a microprocessor (not shown) that includes a CPU and a memory. The control unit 10 controls an operation of the process control valve 32 based on detection signals that are input from the raw water flowmeter and the salt water flowmeter (both not shown). A memory stores in advance a control program for performing an operation of the water softening device 3 according to the present embodiment. The CPU of the control unit 10 controls the process control valve 32 to sequentially switch the water-softening process ST1 to the water supplementing process ST6, following the control program that is stored in the memory.

In the water treatment system 1 that is configured as described above, the raw water W1 that is supplied from a supply source (not shown) of the raw water W1 via the raw water line L1 is delivered to the process control valve 32 of the water softening device 3 by the raw water pump 2. The raw water W1 is softened by passing the cation exchange resin bed 311 of the pressure tank 31, and the soft water W2 is produced. The soft water W2 is further delivered to the reverse osmosis membrane separation device 5 via the soft waterline L2. In the reverse osmosis membrane separation device 5, a membrane separation process is performed to the soft water W2 by the RO membrane module 5b, and the permeate water W5 and the concentrated water WE are produced. Thereafter, the permeate water W5 obtained is delivered to the secondary refining device or to the demand position as desalinated salt water via the water passage line L5.

According to the water treatment system 1 according to the embodiment described above, the following effect is obtained, for example.

In the water treatment system 1 according to the present embodiment, the cation exchange resin bed 311 of the water softening device 3 has the depth D1 (see FIGS. 2) of 300 to 1500 mm, and also has the ratio (D1/Z) of the depth D1 set to the diameter Z to 1.8 to 3. The water treatment system 1 is operated by including the regeneration process ST3 of regenerating the whole of the cation exchange resin bed 311 by generating an opposed flow of the salt water W3 by collecting the salt water W3 by the intermediate screen 323 while distributing the salt water W3 to the top screen 321 and the bottom screen 322 of the cation exchange resin bed 311, respectively. Therefore, the soft water W2 of high purity from which a hardness leakage level is sufficiently decreased can be obtained to a maximum extent in a practical range of a water collection volume, without generating a regeneration-insufficiency portion due to a short circuit flow or a drift current of the regenerant.

In the water treatment system 1 according to the present embodiment, in the regeneration process ST3, the salt water W3 in a volume which gives a regeneration level of at least 1 to 6 eq/L-R is supplied to the hardness leak prevention bed 313 having the depth D2 (see FIG. 2) of 100 mm based on the bottom portion of the cation exchange resin bed 311 as a base point. Therefore, in the cation exchange resin bed 311, the hardness leak prevention bed 313 as an exit region important to prevent a hardness leakage can be substantially completely regenerated. According to this, in the water-softening process ST1, even when hard water of a poor water quality with a high hardness level as the raw water W1 is used, the high-purity soft water W2 in which a hardness leakage level is suppressed to a maximum extent can be obtained.

Therefore, according to the water treatment system 1 of the present embodiment, the soft water W2 of high purity can be constantly supplied to the reverse osmosis membrane separation device 5, even when hard water of poor water quality is used for the raw water W1 in the water-softening process ST1. Therefore, a high salt rejection rate and a high permeate water volume can be maintained, by suppressing adhesion and deposition of scales, as well as suppressing oxidization degradation of the RO membrane module 5b.

In the water treatment system 1 according to the present embodiment, in the regeneration process ST3, the system is operated to pass the salt water W3 to the cation exchange resin bed 311 of the water softening device 3 at a linear velocity of 0.7 to 2 m/h. In the displacement process ST4, the system is operated to pass the raw water W1 to the cation exchange resin bed 311 of the water softening device 3 at a linear velocity of 0.7 to 2 m/h and also by a displacement volume of 0.4 to 2.5 BV. By setting the linear velocity of the liquid passed in the regeneration process and the displacement process as specified above, regeneration efficiency of the cation exchange resin bed 311 can be increased, and a water collection volume of the soft water W2 can be increased. By limiting the displacement volume of the displacement process as specified above, purity of the soft water W2 can be increased by suppressing contamination of the hardness leak prevention bed 313 due to a hardness component, even when hard water of poor water quality is used for the displacement water.

Although the preferred embodiment is described above, the present invention is not limited to the embodiment described above, and can be implemented by various modes.

For example, a raw water tank for supplying the raw water W1 to the raw water line L1 is provided separately from the supply source of the raw water W1, and a facility that includes this raw water tank may be used for a raw water supply unit. In this case, the raw water W1 that is stored in the raw water tank is supplied to the water softening device 3 as cleaning water, displacement water, and rinse water.

According to the embodiment, it is possible to provide a method for operating a water softening device and a water softening device capable of producing high-purity soft water from which a hardness leakage level is sufficiently decreased even when hard water of poor water quality is used, by substantially completely regenerating an exit region.

What is claimed is:

1. A method for operating a water softening device, comprising:
producing soft water by passing raw water downward through a cation exchange resin bed which has a depth of 300 to 1500 mm and a ratio of the depth to a diameter being 1.8 to 3; and
regenerating a whole of the cation exchange resin bed by generating an opposite flow of a regenerant by collecting the regenerant at an intermediate portion of the cation exchange resin bed while supplying the regenerant from both sides of a top portion and a bottom portion of the cation exchange resin bed, wherein
the regenerating includes supplying the regenerant in a volume which gives a regeneration level of at least 1 to 6 eq/L-R, to a hardness leak prevention bed having a depth of 100 mm on the bottom portion of the cation exchange resin bed, and
the producing after the regenerating includes supplying raw water having an electric conductivity of equal to or lower than 150 mS/m and having a total hardness of equal to or lower than 500 mgCaCO₃/L.

2. The method for operating the water softening device according to claim 1, further comprising:
displacing, after the regenerating, the regenerant, by generating an opposed flow of the raw water by collecting the regenerant at the intermediate portion of the cation exchange resin bed, while supplying the raw water from the both sides of the top portion and the bottom portion of the cation exchange resin bed, wherein
the regenerating includes passing the regenerant to the cation exchange resin bed at a linear velocity of 0.7 to 2 m/h, and
the displacing includes passing the raw water to the cation exchange resin bed at a linear velocity of 0.7 to 2 m/h, and by a displacement volume of 0.4 to 2.5 By.

3. A water softening device comprising:
a pressure tank configured to accommodate a cation exchange resin bed having a depth of 300 to 1500 mm and having a ratio of the depth to a diameter being 1.8 to 3;
a valve unit configured to switch between a water-softening process in which soft water is obtained by passing raw water downward through the cation exchange resin bed and a regeneration process in which a whole of the cation exchange resin bed is regenerated by generating an opposite flow of a regenerant by collecting the regenerant at an intermediate portion of the cation exchange resin bed while supplying the regenerant from both sides of a top portion and a bottom portion of the cation exchange resin bed;
a regenerant supply unit configured to supply the regenerant in a volume which gives a regeneration level of at least 1 to 6 eq/L-R, to a hardness leak prevention bed having a depth of 100 mm on a bottom portion of the cation exchange resin bed, in the regeneration process; and
a raw water supply unit configured to supply raw water having an electric conductivity of equal to or lower than 150 mS/m and having a total hardness of equal to or lower than 500 mgCaCO₃/L, in the water-softening process after the regeneration process.

4. The water softening device according to claim 3, wherein
the valve unit is configured to switch a process to a displacement process in which the regenerant is displaced, by generating an opposed flow of the raw water by collecting the regenerant at the intermediate portion of the cation exchange resin bed, while supplying the raw water from the both sides of the top portion and the bottom portion of the cation exchange resin bed, after the regeneration process,
the regenerant supply unit is configured to pass the regenerant to the cation exchange resin bed at a linear velocity of 0.7 to 2 m/h, in the regeneration process, and
the raw water supply unit is configured to pass the raw water through the cation exchange resin bed at a linear velocity of 0.7 to 2 m/h, and by a displacement volume of 0.4 to 2.5 BV, in the displacement process.

5. The method for operating the water softening device according to claim 1, wherein the regeneration level is a regeneration agent volume that is used to regenerate a cation exchange resin of a unit capacity.
